(19) United States
(12) Patent Application Publication
(10) Pub. No.: US 2024/0227309 A1
(43) Pub. Date: Jul. 11, 2024

(54) THREE-DIMENSIONAL OBJECTS CERTIFICATION

(71) Applicant: Hewlett-Packard Development Company, L.P., Spring, TX (US)

(72) Inventors: Marc Clotet Marti, Sant Cugat del Valles (ES); Yelena Helen Balinsky, Bristol (GB); Manuel Lopez Alarcon, Sant Cugat del Valles (ES)

(21) Appl. No.: 18/563,906

(22) PCT Filed: Jun. 2, 2021
(86) PCT No.: PCT/US2021/035458

§ 371 Date: Nov. 23, 2023

(51) Int. Cl. B29C 64/393; B33Y 40/00; B33Y 50/02

(52) U.S. Cl. CPC B29C 64/393; B33Y 40/00; B33Y 50/02

(57) ABSTRACT

According to an example, a method to certify 3D objects comprises receiving a request to certify a 3D object printed by a 3D printer, obtaining printer state data relating to a recorded state of the 3D printer and intended state data relating to an intended state of the 3D printer at a time when the 3D object was printed, determining if the recorded state of the 3D printer is in compliance with the intended state of the 3D printer, and approving the request to certify the 3D object if the recorded state is determined to be in compliance with the intended state.

### BACKGROUND

Some three-dimensional printing systems generate three-dimensional (3D) objects by forming layers of build material and selectively solidifying portions thereof. Other three-dimensional printing systems may generation objects in a different manner.

### BRIEF DESCRIPTION OF DRAWINGS

Features of the present disclosure are illustrated by way of example and are not limited in the following figure(s), in which like numerals indicate like elements, in which:

FIG. 1 shows a method to certify 3D printed objects, according to an example of the present disclosure;

FIG. 2 shows a flowchart representing a method for certifying 3D objects, according to an example of the present disclosure;

FIG. 3 shows a schematic drawing illustrating a three-dimensional printing system and printer state data related to the three-dimensional printing system, according to an example of the present disclosure;

FIG. 4 shows a system to receive certification requests for 3D objects, according to an example of the present disclosure;

FIG. 5 shows a computer-readable medium comprising instructions, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent, however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Additive manufacturing, or three-dimensional printing, techniques may generate three-dimensional objects through the solidification of build material. In an example, the build material is a powder-like granular material, which may for example be a plastic, ceramic, or metal powder and the properties of generated objects may depend on the type of build material and the type of solidification mechanism used. Build material may be deposited, for example, on a build platform and processed layer by layer, for example within a build chamber of an additive manufacturing system.

In some examples, selective solidification is achieved through directional application of energy, for example using a laser or an electron beam which results in melting, and subsequent solidification, of build material where the directional energy is applied. In other examples, at least one print agent may be selectively applied to the build material and may be liquid when applied. For example, a fusing agent may be selectively distributed onto portions of a layer of build material in a pattern derived from data representing a slice of a three-dimensional object to be generated (which may, for example, be determined from structural design data). The fusing agent may have a composition that absorbs energy such that, when energy (for example, heat) is applied to the layer, the build material to which it has been applied heats up, coalesces, and solidifies, upon cooling, to form a layer of the three-dimensional object in accordance with the pattern. In other examples, coalescence may be achieved in some other manner.

In some examples, in addition to a fusing agent, a print agent may comprise a detailing agent, which acts to modify the effects of a fusing agent for example by reducing or increasing coalescence or to assist in producing a particular finish or appearance of an object. In some examples, a detailing agent may be used near edge surfaces of an object being printed to reduce thermal bleed.

As noted above, three-dimensional printing systems may generate three-dimensional objects based on structural design data. This may involve a designer designing a three-dimensional model of a three-dimensional object to be generated, for example using a computer-aided design (CAD) application. A print job may define the solid portions of a series of three-dimensional objects having a spatial arrangement within a build chamber of the three-dimensional printing system. To generate the three-dimensional object defined by the print job within a build unit of a three-dimensional printing system, the print job may comprise, or may be processed to derive, slices or parallel planes of the object models. Each slice may define a portion of a respective layer of build material that is to be solidified or caused to coalesce by the additive manufacturing system to generate a layer of the object.

In some examples, the three-dimensional printing systems may perform post-processing operations (such as cleaning operations) in order to obtain the three-dimensional objects as designed in the structural design data. For example, three-dimensional objects formed in a powder-based 3D printing system may have to undergo a de-caking and/or cleaning operation to separate the generated objects from non-solidified build material. The de-caking and/or cleaning operations may be performed within a three-dimensional printer or may be performed by using an external device. In some examples, a post-processing operation may be carried out in parallel over the 3D object while a cleaning operation is being performed in the cleaning station.

Throughout the description, the term “3D object” will be used to refer to the three-dimensional object obtained after extracting the non-fused build material from a build cake. However, in other examples in which other types of technologies are used, the 3D object may refer to the finished part obtained upon the manufacturing process has been performed. Examples of different three-dimensional technologies comprise selective laser sintering, fused deposition modeling, amongst others. Examples of other non-3D printing technologies comprise, for instance, computer numerical control machining.

The properties of a three-dimensional objects are based on a number of factors that may include one or more of: the geometrical design of the object; the type of material from which the object is generated; the type of technology, such as the type of 3D printing technology that is used in the object; the type (if any) and nature of any post-processing performed on the generated object; and the state of a particular apparatus used in the object generation. Variations in any of the above factors may affect properties of the generated object that may include one or more of: the density of the 3D object; the stiffness of the 3D object; the roughness of the 3D object; the elasticity of the 3D object; the resilience of the 3D object; the hardness of the 3D object; the geometry of the 3D object; the color of the 3D object, and the fatigue limit of the 3D object.

It can be generally assumed that a 3D object generated by a 3D printer that was in an intended state will have acceptable properties. By intended state is meant that the 3D printer was comprised of a set of components in a known component configuration. For example, a new 3D printer can, in general, be assumed to generate 3D objects having acceptable properties as the printer will be in a state intended by a printer manufacturer.

However, a 3D printer which has been subjected to repair or to component replacement (for example, following an upgrade) may not be in a state as intended by the manufacturer, for example, if certain components have been replaced with non-approved components, or if components have not be upgraded as intended.

Furthermore, the manufacturer may, over time, modify the intended state of a 3D printer for example to improve functionality of the printer, for example by updating firmware within the printer or by changing component specifications. Thus, a 3D printer may no longer be in an intended state if modifications to the intended state of the printer are made (e.g. by the manufacturer) and if the 3D printer is not upgraded or modified to be compliant with the modified intended state.

In many situations it may be desirable, or even necessary, to determine whether a given 3D object can be ‘certified’ as having been generated by a 3D printer that was, at the time the object was generated, in an intended state. A 3D printer having such intended state may thus be assumed to generate 3D objects of an acceptable quality, or to have some other assumed properties or qualities. Examples described herein thus provide systems and methods to ‘certify’ an object by determining whether the 3D object was generated by a 3D printer that was in an intended state when the object was generated. When a 3D printer is considered to be in an intended state, it will be understood that the 3D objects printed by such 3D printer are ‘certified’. It should be noted, however, that ‘certified’ as used herein does not guarantee that an object is fit for any particular purpose, as this may also be based on the design of the object and the type of material used to generate the object.

In many cases a request to certify an object may be made quite some time after the object was generated. According to an example, a method to certify 3D objects generated by a 3D printer may be performed in order to certify that the 3D printer that generated the 3D object was in an intended state at a time the 3D object was generated. In the intended state, the 3D printer is considered to generate 3D objects with at least one of an acceptable quality, acceptable mechanical properties, and acceptable non-mechanical properties. In an example, the intended state may be defined by intended state data which defines a set of requirements defined by a suitable certification provider such as the 3D printer manufacturer. The method may comprise obtaining, from a database, printer state data relating to a recorded state of the 3D printer that generated the 3D object at the time the object was generated. The printer state data may comprise information relating at least one of mechanical aspects of the 3D printer (such as component and subcomponents) and firmware aspects of the 3D printer (such as a firmware version of a processor-related component). In order to determine if the 3D printer that generated the 3D object was in compliance with a configuration defined by the manufacturer, the method further comprises obtaining intended state data that defines the intended state of the 3D printer at the time the 3D object was generated. In some examples, the intended state data may have been generated by the certification provider or may be directly obtained from a different provider, for instance from a provider server or a provider database.

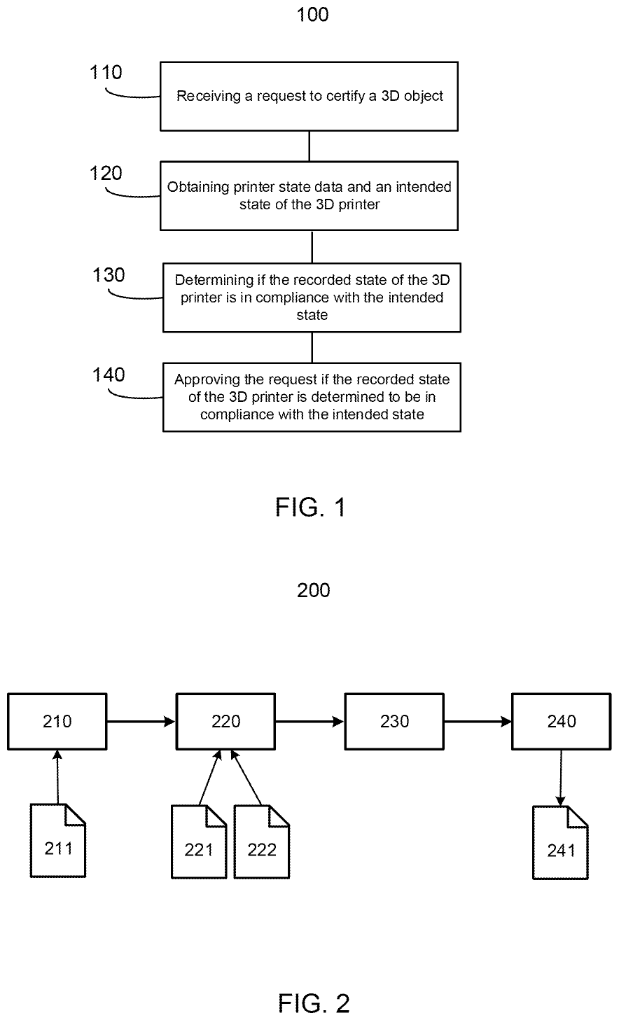

Referring now to FIG. 1, a method 100 to certify 3D printed objects is shown. Method 100 may be used to determine whether or not a 3D object was generated by a 3D printer that was in an intended state at the time the object was generated. The intended state may be defined in intended state data provided by, for example, the printer manufacturer or designer.

At block 110, method 100 comprises receiving a request to certify a 3D object printed by a 3D printer. The request may have been submitted by a user or may be automatically generated as a part of a process, e.g. a certification request automatically generated before packing 3D printed objects in a shipping process.

In an example, receiving a request to certify a 3D object printed by a 3D printer (block 110) comprises obtaining from the request an identifier associated with the 3D object and identifying, based on the identifier, a time when the 3D object was generated and a 3D printer that generated the 3D object. In other examples, the requester may submit along with the request a time, such as a date stamp, when the 3D object was printed. The identification of the 3D printer used to generate the object and the time at which the object was generated may be obtained, for example, from a suitable database.

At block 120, method 100 comprises obtaining printer state data relating to a recorded state of the 3D printer and intended state data of the 3D printer that generated the object. In an example, the printer state data is obtained from a database that may be maintained by a service engineer, or automatically in the case of firmware updates, as and when any modifications to the state of the 3D printer.

In one example, access to the printer state data database may be secured by suitable access authentication processes. In other examples, the database may be a distributed ledger (such as a blockchain-based database) comprising a set of blocks and a set of transactions. In order to determine the allowability of the certification requests, the distributed ledger may use a smart contract to determine if a requester owns sufficient access rights to request a certification for a 3D object. In a similar way to obtaining the printer state data, the intended state of the 3D printer may be obtained from a database. The database may, in one example, be the same database in which the printer state data is stored or a different database. In other examples, instead of a database, obtaining printer state data and intended state of the 3D printer may comprise accessing a readable-memory in which data has been previously stored.

At block 130, method 100 comprises determining if the recorded state of the 3D printer defined by the printer state data complies with the intended state data of the 3D printer. In an example, determining if the recorded state of the 3D printer complies with the intended state data comprises determining, from the printer state data, data relating to a set of components forming the 3D printer at a time when the 3D object was printed, determining, from intended state data, the intended state of the 3D printer, and determining whether the 3D printer was in the acceptable state at the time when the 3D object was printed.

In an example, determining if the recorded state of the 3D printer complies with the intended state comprises determining, from the printer state data, a set of firmware versions for processor-related components of the 3D printer, determining, from intended state data a set of corresponding intended firmware versions, and determining therefrom whether the 3D printer was in an acceptable state at the time when the 3D object was printed. By ‘acceptable’ state means that any differences between the determined state and the intended state are within acceptable limits that may be defined by, for example, the printer manufacturer. For example, a firmware version may be deemed to be acceptable if it is within the same major firmware release version (e.g. a current firmware version 1.8 may be considered to be acceptable if the current intended firmware version is version 1.9, but not if the current intended firmware version is version 2.0).

At block 140, method 100 comprises approving the request if the recorded state of the 3D printer is determined to be in compliance with the intended state of the 3D printer. In an example, approving the request to certify the 3D object comprises issuing a certificate of compliance for the 3D object.

In some examples, determining if the printer state data complies with the intended state (i.e., if the recorded state complies the intended state) of the 3D printer may further comprise determining if the printer state data acceptably matches the intended state data. In an example, determining if the printer state data acceptable matches the intended state data comprises determining whether a set of components defined by the intended state data of the 3D printer are acceptably matched by the printer state data at the time the 3D object was printed. For example, some components, such as visual indicators, user interface features, or the like, may not have a material effect on the properties of an object, and may thus may either not be comprised in the intended state data, or may not be taken into consideration when determining whether the state of a printer complies with an intended state.

Throughout the description, the term “processor-related component” will be used to refer to the components which are involved in the generation of the 3D object which are subjected to a firmware version, i.e. components that may have internal memories or external memories to store instructions/software. Examples of processor-related components subjected to updates are a movable platform system, a heating system, and a layering system. Examples of non-processor-related components are, for instance, electronic components (such as LEDs) that may belong to the heating system or non-electronic components (such as recoater rollers or pneumatic systems) belonging to the layering device. Such non-processor-related components are not subjected to firmware updates.

In other examples, obtaining printer state data and the intended state of the 3D printer (block 120) comprises submitting an access request to access a database, determining access rights of a requester, and authorizing the access request if the access rights allow fulfilling the access request. In other examples in which the database is a distributed ledger comprising a set of blocks and a set of transactions, obtaining printer state data and intended state data of the 3D printer may comprise submitting an access request to the distributed ledger, determining access rights of a requester, authorizing the access request if the access rights allow fulfilling the access request, and adding an additional block to the set of blocks and an additional transaction to the set of transactions, wherein the additional block and the additional transaction are associated with the access request submitted by the requester. In order to validate the access rights of users to the distributed ledger, smart contracts may be used. Such smart contracts may validate the access legitimacy for a user, for instance by asking the user to provide an electronic certificate, an access code, validated biometric information, among others.

In some other examples, method 100 may further comprise generating certification data associated with the request to certify the 3D object and adding the generated certification data to a certification database.

According to some examples, distributed ledgers may be used as a trustable source of information in which every change performed to a 3D printer is stored. These changes, as previously described, include both physical changes (for instance a replacement/upgrade of a component or a subcomponent) and software changes (for instance a firmware update or an update of a processor-related component or subcomponent). In order to increase the levels of trust, the records added to the ledger may be immutable records, and hence, users with appropriate access rights will be able to see the records but not able to modify them. In other examples, the records may be time stamped in order to prevent reproduction of the record(s), modification of the record(s), or falsification of the record(s) at a later stage. When using distributed ledgers, additional security levels are obtained with respect to other types of databases such as centralized ledgers.

Referring now to FIG. 2, a flowchart 200 representing a method for certifying a 3D object generated by a 3D printer is shown. As previously explained in reference to FIG. 1, 3D objects may be certified based on printer state data associated with a recorded state of the 3D printer at a time when the 3D object was printed and intended state data associated with an intended state of the 3D printer.

At block 210, flowchart 200 comprises receiving a request from a requester to certify a 3D object. The request may have been manually or automatically submitted, as previously explained in other examples. In order to obtain object data 211 associated with the 3D object, the request may comprise an identifier for the 3D object so that the object data 211 can be obtained. Object data 211, which may be stored in a database, a server, or a readable-memory, may comprise information about the 3D printer at the time when the 3D object was printed such as the 3D printer used to generate the 3D object, the number of 3D objects that were printed in the same batch, among others. In an example, object data 211 associated with the 3D object may be obtained based on the identifier, wherein the object data comprises information about the 3D printer that generated the 3D object and the time when the 3D object was printed.

At block 220, flowchart 200 comprises obtaining printer state data 221 relating to the recorded state of the 3D printer at the time when the 3D object was printed and intended state data 222 defining an intended state of the 3D printer. In an example, the printer state data 221 may be a manufacturing bill of materials (m-BOM) that contains information related to the components and subcomponents of the 3D printer at the time when the 3D object was printed. The m-BOM may comprise detailed information about the components defining the recorded state of the 3D printer, such as performance data, installation data, components' supplier, technical assistance carried out over each of the components, versions of the processor-related components, or environmental conditions in which the 3D object was generated.

Depending on the component, the information available may vary. As previously explained, processor-related components may comprise additional information about a firmware version with respect to non-processor-related components. Similarly, the intended state included in the intended state data 222 may be an engineering bill of materials (e-BOM) for the 3D printer, wherein the e-BOM defines a list of elements and specifications to certify the intended state of the 3D printer. The e-BOM may be defined, for instance, by a certification provider such as the manufacturer of the 3D printer. The e-BOM may comprise detailed information about a set of certified components that the 3D printer is to be formed of, a certified performance data of the components and/or the 3D printer, a certified component supplier, a schedule of quality audits that the 3D printer should have been gone through to assure an appropriate performance, a certified set of environmental conditions (such as humidity ranges or temperature ranges), among others. Depending on the type of certification request, the intended state data 222 may comprise additional (or fewer) requirements.

At block 230, flowchart 200 comprises determining whether the printer state data 221 is in compliance with the intended state data 222, i.e. comparing the m-BOM with the e-BOM. The determination may be performed, for instance, by checking each of the requirements defined by the intended state data 222. The intended state defined by the intended state data 222 may comprise, for instance, at least one of a specific type of heating lamp, a specific type of build material, a specific layer thickness, and a specific coalescing agent. If the recorded state defined by printer state data 221 associated with the 3D printer that printed the 3D object matches with the set of requirements defined by the intended state data 222, i.e. the type of heating lamps, the type of build material, the layer thickness, and the coalescing agent, the printer state data 221 is determined to be in compliance with the intended state data 222. In some examples, the intended state data 222 defines a set of critical components that may have a material impact on properties of the 3D object generated by the 3D printer. Although other components of the 3D printer may be defined in the recorded state of the 3D printer, the impacts derived from these components may not be important for the certification defined by the intended state of the 3D printer.

At block 240, flowchart 200 comprises approving the request to certify the 3D object if the recorded state defined by the printer state data 221 is determined to be in compliance with the intended state defined by the intended state data 222. To provide proof of the certification, block 240 may comprise generating certification data 241 associated with the request to certify the 3D printer that generated the 3D object. Such certification data 241 may be added to a certification database or stored in a memory.

In other examples, the flowchart 200 may further comprise additional blocks in order to validate the access rights of a requester. In an example, the requesters may provide an electronic certificate along with the request in order to authenticate their identity. In other examples, the requesters may provide an access code in order to certify that they own rights sufficient to request a certification of a 3D object generated by a 3D printer. In some examples, the access rights of a user are set by a smart contract.

According to an example, a method to certify a 3D object may determine that a recorded state of the 3D printer used to is not in compliance with an intended state of the 3D printer. In an example, a method to certify a 3D object may further comprise identifying if a current recorded state defined by the printer state data is in compliance with the intended state defined by the intended state data. If the states do not appropriately match, the method may further comprise identifying differences between the current recorded state and the intended state of the 3D printer.

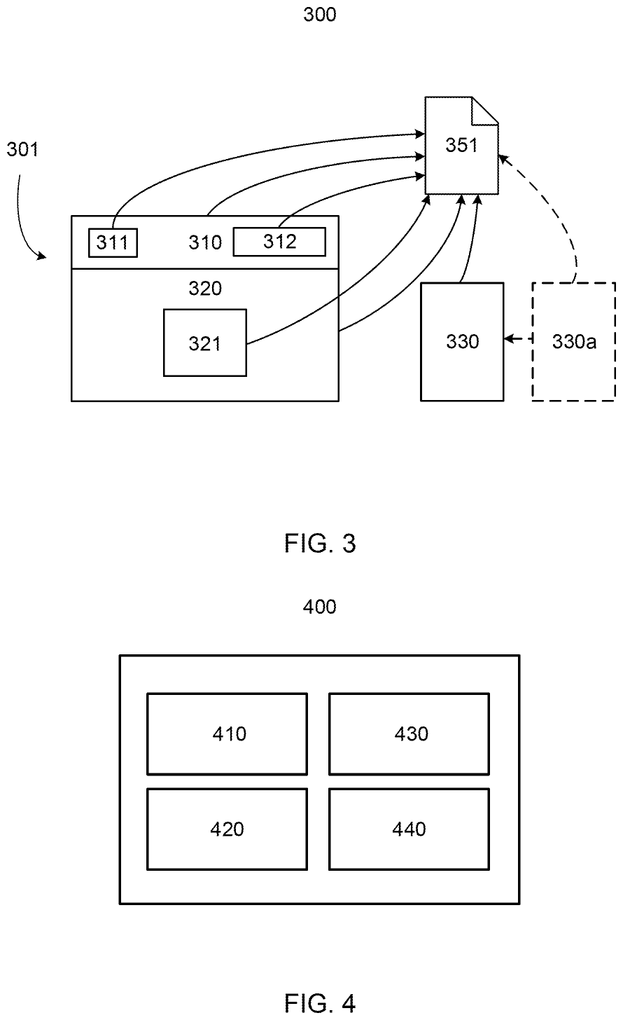

Referring now to FIG. 3, a schematic drawing 300 illustrating a 3D printing system 301 and printer state data 351 is shown. As previously explained, the printer state data 351 defines the state of the 3D printing system 301, wherein the state comprises at least one of data relating to a set of components forming the 3D printing system 301 at a specific time, versions of processor-related components that may belong to the 3D printing system 301, performance data of printer and the components of the 3D printing system 301, the environmental condition associated with the time for which the state is defined, data related to quality audits that the printer has gone through, among others.

In order to define the contents of the printer state data 351, the printer state data 351 may be originally set up by the manufacturer. During the installation of the 3D printing system 301, the features installed in the 3D printing system 301 may be updated to a database. Such information may be structured, for instance, by using a tree-based data structure in which the sub-components of the 3D printing system 301 are dependent from a component. For every component, an identifier may be created. Hence, upon a change occurs in the 3D printing system 301 (for instance, a component replacement or a software update for a component), the information associated with the affected component is updated in the data structure. In order to keep track of the modifications that the 3D printing system 301 has suffered, the new information associated with the new component is added to the printer state data 351. By using this type of data structure, printer state data 351 stores every state of the 3D printing system 301 over a period of time (for instance, the lifecycle of the 3D printer). Since the 3D printing systems 301 may have connectivity capabilities (for instance, via Internet connection), the printer state data 351 may be updated every time that a modification occurs. However, in other examples, the printer state data 351 may be stored locally and periodically updated to the database. In some examples, the intended state of the 3D printer at a specific time corresponds with the printer state data 351 originally set up by the manufacturer at the specific time.

In the example of FIG. 3, the 3D printing system 301 comprises a first component 310, a second component 320, and a third component 330. The first component 310 comprises a first sub-component 311 and a second sub-component 312. The second component 320 comprises a third sub-component 321. For each of the components and subcomponents, a series of characteristics are stored (and/or updated) in printer state data 351. As previously explained, printer state data 351 may contain information related both to mechanical aspects and firmware aspects.

In an example, the printer state data 351 may include information related to the first component 310, the first sub-component 311 and the second sub-component 312. The first component 310 may correspond with a heating system. the first sub-component 311 may correspond with a set of lamps, and the second sub-component 312 may correspond with a temperature sensor to measure a temperature. Accordingly, for the first sub-component 310 (i.e., the set of lamps), the state defined by the printer state data 351 may include information such as a color temperature record during the generation of the 3D object, the number of hours that the lamps have been used, among others. For the second sub-component 312 (i.e., the temperature sensor), the printer state data 351 may include information such as a type of sensor, a record of the temperatures within the build chamber during the generation of the 3D object, a firmware version for the sensor, among others. For the first component (i.e., the heating system), the printer state data 351 may include information such as parameters during printing operations (for instance overall power used by the heating system during a printing operation), a record of the firmware updates for the heating system, among others.

In other examples, the printer state data 351 may include information related to the second component 320 and the third sub-component 321, wherein the second component 320 may correspond with a build chamber in which the 3D object is generated and the third sub-component 321 is a movable platform system to move a build platform within the build chamber. The state defined by printer state data 351 may include information about the build chamber such as operational data, data related to quality audits, environmental conditions during printing operations, among others. Similarly, the printer state data 351 may comprise information about the third sub-component 321, i.e. the movable platform system, such as a firmware version used by the controller, a layer thickness used to manufacture the 3D object, a record of components forming the sub-component, among others.

In some other examples, the printer state data 351 may include information about the third component 330, wherein the third component 330 corresponds to a fresh build material container. Accordingly, in order to define the state of the third component 330, the printer state data 351 may include information such as information about the build material, the build material supplier, or an amount of build material available in the container. Since the build material container is not a processor-related component, the printer state data 351 may not include any type of data related to a software of the container.

In the schematic drawing 300 of FIG. 3, a fourth component 330a is represented in dashed lines. In case of replacing the third component 330 with the fourth component 330a, for instance because the third component 330 is depleted, the printer state data 351 will be updated to include information related to the fourth component 330a. To update the printer state data 351 in accordance with the replacement, an additional block of data associated with the replacement may be added to the printer state data 351. When having a data structure corresponding with a distributed ledger to store the data related to the components, the replacement of the third component 330 with the fourth component 330a may result in the creation of a new immutable record that is subsequently added to the ledger.

According to some examples, the printer state data 351 may be stored in a database. The database may comprise all the information about the printer and its components in a data structure corresponding, for instance, to a Merkle tree, wherein each of the leaves of the Merkle tree corresponds to the subcomponents of the printer, a set of sub-components define a node corresponding to a component, and nodes corresponding to a set of components define the printer. In each of the nodes, information about a specific element may be available. In some examples, every node may be labeled with a cryptographical hash of the labels of its child nodes, thereby proving additional security to the printer state data 351. If the printer state data 351 is to be modified, the modification has to fulfill the security functions defined by the cryptographically hashes. In other examples, the information added the database may be defined as immutable, i.e. a user cannot modify information related to components and/or subcomponents.

According to other examples, the printer state data may be stored in a database defined as a distributed ledger comprising a set of blocks and a set of transactions, wherein the data associated with the blocks and the transactions is spread across multiple locations in order to increase the levels of security and to prevent alteration of the records. In order to access the database, requester access rights may be determined with an electronic certificate defined by a smart contract. In order to determine that the requester is entitled to request such access, verification methods comprising cryptographic keys may be used. Similarly, in order to modify the information defined by the printer state data 351, a new node representing an action must be added to the data structure, i.e. data is added, not replaced.

After determining the allowability of the new node, the rest of the nodes remotely distributed are updated. In an example, the printer state data 351 is stored in a distribute ledger in which the records cannot be modified by the user. Rather, every time that the 3D printing system 301 suffers a change, for instance a component replacement or a firmware update, new records are added to distributed ledger of the printer state data 351 such that the previous records representing previous configurations of the 3D printing system 301 are not deleted nor replaced. Before being added to the ledger, the new records are validated. After the new records have been added, since records are immutable, the record reproduction, modification and falsification are prevented. By preventing the modification of the records, the trust levels of the printer state data 351 are enhanced, thereby increasing the authenticity and the validity of a certification request for a 3D object printed by a 3D printer. In other examples, every time that a record is added to the distributed ledger, the record is timestamped in order to prevent a modification of the records by the user.

Referring now to FIG. 4, a system 400 to receive requests for 3D objects is shown. The system 400 comprises a request module 410 configured to receive a certification request associated with a 3D object printed by a 3D printer, a profile module 420 configured to retrieve from a database intended state data associated with the 3D printer and printer state data associated with the 3D printer at a time when the 3D object was printed, a validation module 430 configured to determine if the intended state data is in compliance with the printer state data, and a certification module 440 configured to approve the request if the validation module 430 determines that the intended state data is in compliance with the printer state data. As previously explained, the requester that submits the certification request to the request module 410 may be a user or an external device.

In some examples, the intended state may comprise a set of conditions that a 3D printer has to fulfill in order to be under the intended state defined by, for instance, the manufacturer. Similarly, the printer state data may correspond to the printer state data 351 previously explained in reference with FIG. 3. In some examples, the printer state data may comprise a record of components of the 3D printer at the time when the 3D object was printed, a record of firmware versions for processor-related components of the 3D printer at the time when the 3D object was printed, and a record of operational data of the 3D printer at the time when the 3D object was printed. The record of operational data may be, for instance, data describing some parameters during the generation of the 3D object.

In other examples, the profile module 420 is further configured to determine requester access rights based on the certification request and authorize access to the database if the requester access rights allow the requester to submit the request. In an example, an access rights database identifying the access rights for a set of requesters may be used to determine if the requester access rights enable the requester to submit the request. In other examples, the entitled requesters to submit certification requests may issue to the system an identifier (or passcode) along with the certification, wherein the identifier is associated with the access rights. In further examples, the database may comprise a series of blocks and transaction data, and the profile module 420 may be configured to add request data relating the certification request to the series of blocks and the transaction data. In some other examples, the database may be a distributed ledger and the access rights may be validated by using a smart contract in which the access rights of the users are defined. In further examples, the requester may submit an electronic certificate along with the request in order to validate his/her identity.

In some other examples, the printer state data retrieved by the profile module 420 comprises a record of components of the 3D printer at the time when the 3D object was printed, a record of firmware versions for processor-related components of the 3D printer at the time when the 3D object was printed, and a record of performance data of the 3D printer at the time when the 3D object was printed. The intended state data may comprise, for instance, a record of components certified by a printer manufacturer, a record of certified firmware versions certified by the printer manufacturer, and a record of certified performance data. The validation module 430 may be configured to determine if the record of components, the record of firmware versions, and the record of performance data comply with the record of certified components, the record of certified firmware versions, and the record of certified operational data.

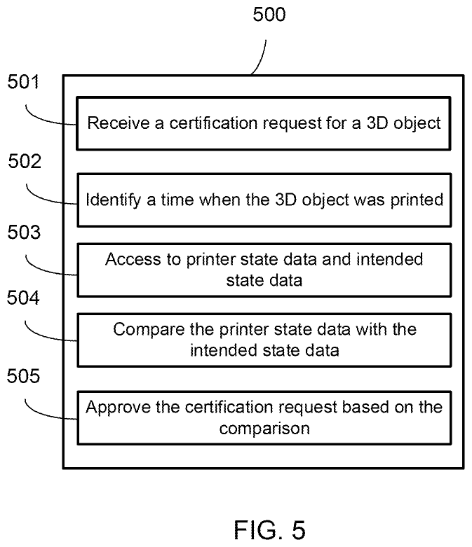

Referring now to FIG. 5, a computer-readable medium 500 comprising instructions is shown. The instructions, when executed by a processor, cause a system to perform a series of actions.

The computer-readable medium 500 may be any non-transitory tangible medium that can embody, contain, store, or maintain instructions for use by a processor. Computer-readable media include, for example, electronic, magnetic, optical, electromagnetic, or semiconductor media. More specific examples of suitable computer-readable media include a hard drive, a random access memory (RAM), a read-only memory (ROM), memory cards and sticks, and other portable storage devices.

In FIG. 5, the computer-readable medium 500 comprises a set of instructions including a first instruction 501, a second instruction 502, a third instruction 503, a fourth instruction 504, and a fifth instruction 505. The first instruction 501, when executed by a processor, causes the system to receive a certification request for a 3D object printed by a 3D printer. The certification request may have been previously submitted by a requester. The request may be submitted in order to determine whether or not the 3D printer was in an intended state when the 3D object was generated. As previously explained, the requester may be a user or an external device. In an example, receive the certification request further comprises obtain from the certification request an identifier associated with the 3D object and identify the time when the 3D object was printed by the 3D printer based on the identifier. The second instruction 502 causes the system to identify a time when the 3D object was printed. The third instruction 503 of the computer-readable medium 500 causes the system to access printer state data relating to a recorded state of the 3D printer and intended state data relating to an intended state of the 3D printer at the time when the 3D object was printed. The printer state data may be, for instance, printer state data 351 previously explained in FIG. 3. Then, the fourth instruction 504 causes the system to compare the printer state data with the intended state data. The comparison enables to determine if the recorded state of the 3D printer defined by the printer state data complies with the intended state of the 3D printer defined by the intended state data, i.e. if the 3D printer that printed the 3D object was the intended state defined by the intended state data at the time when the 3D object was printed. Upon the comparison has been performed, the fifth instruction 505 causes the system to approve the certification request based on the comparison. If the comparison determines that the printer state data is in compliance with the intended state data, the computer-readable medium 500 may comprise further instructions to generate certification data associated with the certification request of the 3D object and add the generated certification data to a certification database. If the comparison determines that the printer state data is not in compliance with the certification profile, the computer-readable medium 500 may comprise further instructions to execute additional actions such as determine the differences between printer profile and intended state data and create an assistance ID to bring the 3D printer into conformity with the requirements set by intended state data.

According to an example, the computer-readable medium may comprise instructions which, when executed by a processor, cause a system to perform the methods previously explained in reference with FIGS. 1 and 2. In an example, the system may correspond to the system 400, i.e. the system may comprise a request module 410, a profile module 420, a profile validation module 430, and a certification module 440.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims (and their equivalents) in which all terms are meant in their broadest reasonable sense unless otherwise indicated.

What is claimed is:

1. A method comprising:
receiving a request to certify a 3D object printed by a 3D printer;
obtaining printer state data relating to a recorded state of the 3D printer and an intended state of the 3D printer at a time when the 3D object was printed;
determining if the recorded state of the 3D printer is in compliance with the intended state of the 3D printer; and
approving the request to certify the 3D object if the recorded state of the 3D printer is determined to be in compliance with the intended state.

2. The method of claim 1, wherein approving the request to certify the 3D object comprises issuing a certificate of compliance for the 3D object.

3. The method of claim 1, wherein receiving the request to certify the 3D object printed by the 3D printer comprises:
obtaining from the request an identifier associated with the 3D object; and
obtaining object data associated with the 3D object based on the identifier,
wherein the object data comprises information about the 3D printer that printed the 3D object and the time when the 3D object was generated.

4. The method of claim 1, wherein determining if the recorded state of the 3D printer is in compliance with the intended state of the 3D printer comprises:
determining, from the printer state data, data relating to a set of components forming the 3D printer at the time when the 3D object was printed;
determining, from intended state data associated with the intended state of the 3D printer, data relating to a set of certified components that the 3D printer was intended to be formed of; and
determining, from the printer state data and the intended state data, whether the 3D printer was in the intended state at the time when the 3D object was printed.

5. The method of claim 1, wherein determining if the recorded state of the 3D printer is in compliance with the intended state of the 3D printer further comprises:
determining, from the printer state data, data relating to a set of firmware versions for processor-related components;
determining, from intended state data associated with the intended state of the 3D printer, data relating to a set of certified firmware versions for processor-related components that the 3D printer was intended to have; and
determining from the printer state data and the intended state data whether the 3D printer was in the intended state at the time when the 3D object was printed.

6. The method of claim 1, wherein obtaining printer state data relating to the recorded state of the 3D printer and the intended state of the 3D printer at the time when the 3D object was printed comprises:
submitting an access request to access a database, the database being a distributed ledger comprising a set of blocks and a set of transactions;
determining access rights of a requester;
authorizing the access request if the access rights allow to fulfil the access request; and
adding an additional block to the set of blocks and an additional transaction to the set of transactions, wherein the additional block and the additional transaction are associated with the access request submitted by the requester.

7. The method of claim 1, wherein determining if the recorded state of the 3D printer is in compliance with the intended state of the 3D printer comprises:
determining if the recorded state acceptably matches the intended state of the 3D printer.

8. A system comprising:
a request module configured to receive from a requester a certification request associated with a 3D object printed by a 3D printer;
a profile module configured to retrieve from a database intended state data for the 3D printer and printer state data of the 3D printer at a time when the 3D object was printed;
a validation module configured to determine if the intended state data is in compliance with the printer state data; and
a certification module configured to approve the certification request if the validation module determines that the intended state data is in compliance with the printer state data.

9. The system of claim 8, wherein the printer state data comprises:
a record of components of the 3D printer at the time when the 3D object was printed;
a record of firmware versions for processor-related components of the 3D printer at the time when the 3D object was printed; and
a record of performance data of the 3D printer at the time when the 3D object was printed.

10. The system of claim 9, wherein the intended state data comprises a record of components certified by a printer manufacturer, a record of certified firmware versions certified by the printer manufacturer, and a record of certified performance data, wherein the validation module is configured to determine if the record of components, the record of firmware versions, and the record of performance data comply with the record of certified components, the record of certified firmware versions, and the record of certified performance data.

11. The system of claim 8, wherein the profile module is configured to:
determine requester access rights based on the certification request; and
authorize access to the database if the requester access rights allow the requester to submit the certification request.

12. The system of claim 8, wherein the database comprises a series of blocks and transaction data, wherein the profile module is configured to add request data relating to the certification request to the series of blocks and the transaction data.

13. A computer-readable medium comprising instructions that, when executed by a processor, cause a system to:
receive from a requester a certification request for a 3D object printed by a 3D printer;
identify a time when the 3D object was printed;
access to printer state data relating to a recorded state of the 3D printer and intended state data relating to an intended state of the 3D printer at the time when the 3D object was printed;
compare the printer state data with the intended state data; and
approve the certification request based on the comparison.

14. The computer-readable medium of claim 13, comprising further instructions to cause the system to:
generate certification data associated with the certification request of the 3D object; and
add the generated certification data to a certification database.

15. The computer-readable medium of claim 13, wherein receive from the requester the certification request comprises:
obtain from the certification request an identifier associated with the 3D object; and
identify the time when the 3D object was printed by the 3D printer based on the identifier.
